(19) United States
(12) Patent Application Publication
(10) Pub. No.: US 2015/0220226 A1
(43) Pub. Date: Aug. 6, 2015

(54) Method for context-based communication in HTML pages

(71) Applicants: David B. Ellis, San Rafael, CA (US); Rory Allen Smith, Black Hawk, SD (US); Alejandro Ralph Torres, Eastsound, WA (US)

(72) Inventors: David B. Ellis, San Rafael, CA (US); Rory Allen Smith, Black Hawk, SD (US); Alejandro Ralph Torres, Eastsound, WA (US)

(21) Appl. No.: 13/999,264

(22) Filed: Feb. 3, 2014

(51) Int. Cl. G06F 3/0483; G06F 17/30

(52) U.S. Cl. CPC G06F 3/0483; G06F 17/30896

(57) ABSTRACT

A method is disclosed for context-based communication in HTML pages in which embodiments include communications between readers of the HTML content and the creators of the HTML content. The present invention generally relates to the creation and publishing of multiple HTML web pages that may be combined to form a global context as an HTML application. More specifically, the method provides a means to allow readers and authors to create and share content with each other and other readers within the context of a single HTML page or within the context of a grouping of HTML pages in an environment that may have intermittent or unreliable network connectivity.

### RELATED APPLICATIONS

This application claims the priority benefit of U.S. Provisional Application Ser. No. 61/849,931, titled “eBook Method for Connecting Readers to Each Other and the Author,” filed Feb. 5, 2013, the disclosure of which is incorporated herein by reference.

### BACKGROUND INFORMATION

The present invention generally concerns Hypertext Markup Language (HTML) pages. More specifically, the present invention concerns contextual communication among readers and creators of the content of HTML pages.

HTML pages can be created with audio, video, images, and text to represent content such as books, newspapers, articles, and magazines. In many cases, content which has been traditionally offered in print form has been recreated in electronic media in the form of HTML pages. HTML pages representing such content can be viewed on media devices such as desktop and laptop computers, tablets, smart phones, and other web-based, interconnected devices. In some cases, HTML pages can be created to represent a traditional electronic book (e-book) with an author as the creator of the content and its readers. Readers can page through the HTML pages just as readers would navigate the pages of an e-book.

Through the use of server technologies, HTML page content can be enhanced to allow interactive contextual communications among readers of the same HTML content across multiple computer devices connected to a common network such as the Internet. Context-based communication has existed in the form of web blogs and forums where readers can view HTML content and provide comments that are sent to a server for other readers to see and view. The U.S. patent application to Rothschild (US-20120284348; Nov. 8, 2012 discloses a method for receiving input from a reader of an e-book on one mobile device and transmitting an electronic message with the e-book content identifier to a remote media computer server through a communications network. Moreover, the remote media computer server determines a set of third party mobile devices based on the e-book content identifier and transmits the electronic message to each third party mobile device.

Further, the U.S. patent to Lang (U.S. Pat. No. 8,392,504; Mar. 5, 2013) discloses a device application allowing a user to participate in a collaborative discussion associated with media content provided through a media reader application. The disclosure relies on real-time, constant network connectivity for operation.

All of this communication requires a network connection with the information being stored on a central server that provides this content to other network-connected devices. If a device loses network connectivity, that device loses the ability to view new HTML content, as well as losing the ability to create contextual communication.

In an environment where network connectivity is not guaranteed, an ideal solution would be a method that would allow a reader to use and interact with the HTML page content, creating and reading contextual-based reader-generated content regardless of their network connectivity.

### BRIEF DESCRIPTION OF DRAWINGS

FIG. 1 is a block diagram illustrating the system for storing HTML application configurations, reader information, and content created by readers and other users of the system.

FIG. 2 is a block diagram illustrating the components of the HTML application on a mobile device.

FIG. 3 is a block diagram illustrating the components of the HTML application on a desktop device.

FIG. 4 is a flow diagram illustrating the method for creating an HTML application in the system to provide interactivity for the readers.

FIG. 5 is a flow diagram illustrating the method for a reader to register and use the interactive features of the HTML application.

### SUMMARY OF THE INVENTION

Embodiments of the present invention describe a method for providing context-based communication to readers of HTML pages. HTML pages can be created with textual or media content. By creating multiple HTML pages and assigning a global unique identifier, the HTML pages can exist as an entity in one context as an HTML application. Each HTML page in the HTML application can be assigned a page-level unique identifier to represent a page-level context. The global context can be assigned to a reader of the content through a unique registration identifier. Using JavaScript and local storage, a user interface can be created and inserted into the HTML application and assigned a context that will provide a reader with the ability to create contextual content and read contextual content created by other readers of the HTML application.

HTML pages can be viewed in network-connected devices such as computers, tablets, mobile phones, and other smart computer enabled devices. An embodiment of the present invention allows offline viewing of HTML pages and continued use of the HTML application by using JavaScript and local storage to interact with certain aspects of the content.

Another embodiment of the present invention permits the registered reader to create groups of a plurality of readers. These groups are stored in the system and identified by a unique group identifier. The present invention provides a means for a reader to generate content and then share this content with the verified plurality of readers of the created group. Any reader within a group may create and share content with all the verified plurality of readers within a group.

Another embodiment of the present invention permits the registered reader to create and share content with the author of the HTML page, other identified registered readers, or all readers of the HTML page. Each of these sharing methods is distinct and separate and each piece of created content can be shared with any or all of the available sharing options.

Another embodiment of the present invention also permits a reader, whether registered or unregistered, to create content and not share it with any other readers, storing it locally on the device to be retrieved and viewed in the context of the HTML page or HTML application. As a registered reader, the content can also be stored on a server as a secondary means of storage.

Another embodiment of the present invention also permits a registered reader to identify a second registered reader of the HTML application as a third party reader of the registered reader's shared content. The second registered reader can be a teacher, group leader, coach, or other singular registered reader. After the registered reader is identified as the third party reader, they can share content with the second registered reader.

### DETAILED DESCRIPTION

This detailed description sets forth numerous different embodiments of the present invention. It should be understood that the legal scope of the description is defined by the words of the claims set forth at the end of this disclosure. Other embodiments may be utilized but it is not practical to describe every possible embodiment. Numerous alternative embodiments could be implemented, using either current technology or technology developed after the filing date of this patent, which would still fall within the scope of the claims. This description will include system configurations, detailed drawings, and flowcharts. While these details are helpful to explain one or more embodiments of the invention, those persons ordinarily skilled in the art will understand that these specific details are not required in order to implement the embodiments.

In the present invention a method is described for providing context-based communication access to a reader or user of an HTML application. In one embodiment of the present invention, the HTML application is comprised of a plurality of HTML pages whereby the creator or author of the content incorporates text, images, video, or audio while integrating a plurality of user interfaces providing a means for contextual communication between readers of the HTML pages. Upon creating the HTML pages, a global unique identifier is assigned to the HTML pages providing a global context for the group of HTML pages. Within the global context, each individual HTML page is assigned a unique page identifier to provide a singular page context. Together, the HTML pages, user interfaces, and unique identifiers are combined to create an HTML application.

In one embodiment of the present invention a reader accesses a unique copy of the HTML application by downloading an application package to a mobile device. In a second embodiment of the present invention a reader accesses a copy of the HTML application using a web browser on a desktop computer, mobile tablet or phone, or other computerized device.

In another embodiment of the present invention, when a reader first accesses the HTML application, the reader is an unregistered reader and their presence is unknown to the system. An unregistered reader can register their copy of the HTML application with the system by providing unique information such as name, email, and a password. The HTML application will transmit the registration information to the system over a network connection. Upon successful registration, the unregistered reader is assigned a unique registration identifier within the system and becomes a registered reader. Both unregistered and registered readers have access to interactive user interfaces in the HTML application and have the ability to create unique contextual content in the application which is stored locally to the reader's device. As a registered reader, the reader is granted the ability to create context-based content and communicate the content with the author or creator of the content; a teacher, group leader, or coach of the content; all other readers of the content; or groups of other readers of the content.

In another embodiment of the present invention, context-based content is content created by a registered reader and is identified with a page context identifier or a global context identifier. The registered reader can identify this content as being kept private. The registered reader can also identify the content as being available to be read by other registered readers of the HTML application. The other registered readers can access and read this content in the same context as it was created.

In accordance with one embodiment of the present invention, a registered reader may be assigned an additional role of author of the HTML application. In the HTML application, certain context-based content can be identified as being accessible to only registered readers that have been assigned the role of author. As a registered reader that is assigned the role of author, the reader can access and read the author-designated content.

In accordance with one embodiment of the present invention, a registered reader may be assigned an additional role of teacher, group leader, or coach of the HTML application. In the HTML application, certain context-based content can be identified as being accessible to only registered readers that have been assigned the role. As a registered reader that is assigned the role, the reader can access and read the context-based content that is designated for readers with this role of teacher, group leader, or coach.

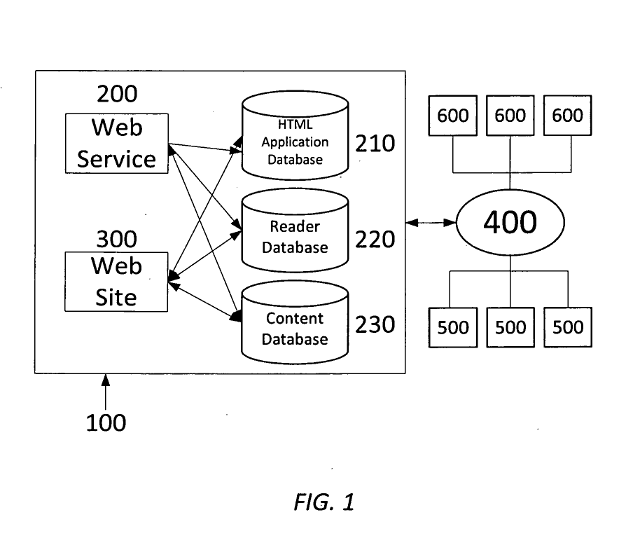

FIG. 1 is a block diagram illustrating an embodiment of the system (100) for storing HTML application configurations, reader information, and content created by readers and other users of the system. Readers in the system download an HTML application and store it in the electronic file system on their mobile device (500). Readers gain access to the system over the Internet (400). This connection can be made over a wired or wireless LAN connected to the Internet, by using a cellular data network with

Internet access, or by other means not identified in this document. The system (100) includes a web service (200) which responds to requests for information from the HTML application on the mobile devices (500). The web service (200) is an application programming interface (API) which retrieves and stores data to and from the HTML application database (210), the reader database (220), and the content database (230). In one embodiment, the system (100) includes a web site (300) which provides access to the HTML application database (210), the reader database (220), and the content database (230) to users of the system that gain access using a web browser from a desktop computer (600) with access to the Internet (400).

The HTML application database (210) contains profile information relating to all HTML applications in the system. This profile information may include the global unique identifier of the HTML application, the title, a description, the author or authors, the date published, and other identifying information of the HTML application. It also contains the definitions for context-based user interfaces within each

HTML application. This information is used by the system (100), the mobile devices (500), and the desktop devices (600) to display and accept input that pertains directly to the various contexts within each HTML application. A context-based user interface is an interactive component within the HTML application that uses HTML, JavaScript, and local storage to provide a method for a reader to provide input to create contextual content and also display input created by other third party readers. The context-based user interface can perform these functions without network connectivity. In the presence of network connectivity, the same context-based user interface can transmit the reader-generated content to a server and also receive third party reader-generated content and store it in local storage for the reader of the local device to access and read at a later time. Persons who are skilled in the art will understand that the specific details of the design of the HTML application and context-based user interface are not necessary to practice these embodiments.

In one embodiment, a context-based user interface may be a notes module which allows the reader to create notes related to the context of the current page. In this embodiment, the reader may also be able to read notes created by other readers within the system (100).

In another embodiment, a context-based user interface may be a messaging module which allows the reader to create messages destined for the author of the HTML application. In this embodiment, the reader may also be able to read messages from the author of the HTML application.

The reader database (220) contains profile information relating to the registered readers in the system. This profile information may include a unique identifier of the reader, name, email address, permissions, roles, associations, and other reader-specific information.

The content database (230) contains reader-created content that has been entered into the system (100) through the HTML applications on mobile devices (500) or the HTML applications on desktop devices (600). This content includes messages which are created by a registered reader of the system (100) and destined for one other registered reader in the system (100). This messaging is initially only between registered readers and an author or teacher or coach assigned to the registered reader. The content also contains notes that are created by registered readers in the system (100) and shared with other registered readers of the system (100).

The HTML application database (210), registered reader database (220), and content database (230) are updated each time a registered reader interacts with the system (100) and network connectivity is present. The web service (200) compiles information from registered readers and stores it in each database. The web service (200) also compiles information and transmits it to each registered reader based on the registered reader profile and their permissions and associations. This transfer of data from the system (100) to the HTML applications (500 and 600) occurs automatically each time the HTML applications are connected to the system through the Internet (400).

In one embodiment, a registered reader accesses the HTML application on a mobile device (500) while there is no connection to the Internet (400). The application is able to function normally and provide the registered reader with the ability to continue to create context-based content and share it with other registered readers. This content will be transmitted to the system (100) through the web service (200) when the mobile device (500) is connected to the Internet (400).

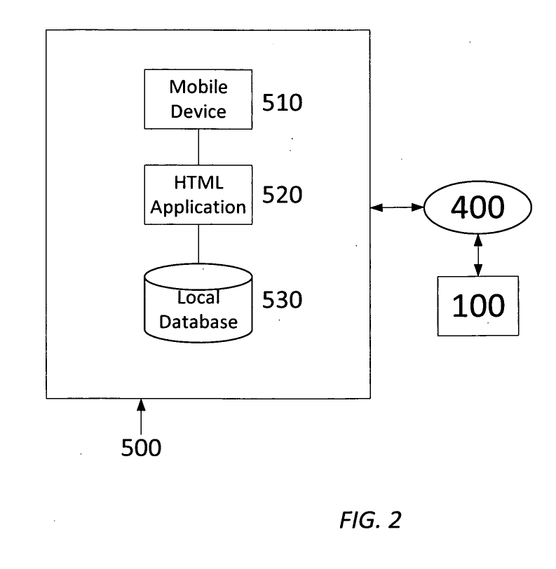

FIG. 2 is a block diagram illustrating the components of one embodiment of the HTML application on the mobile device. The mobile deice (510) is any standard mobile device commonly available such as a tablet, phone, or other intelligent portable device. The HTML application (520) is a mobile application compiled and targeted for each specific mobile device platform (510). The HTML application (520) contains context-based user interfaces which accept reader input and display third party reader-generated content in the context of the location in the HTML application. The local database (530) is used to store unique and identifying information for each instance of an HTML application on the device. This local database (530) is stored locally and updated by input from a reader of the HTML application and also from data received and transmitted over the Internet (400) to and from the system (100).

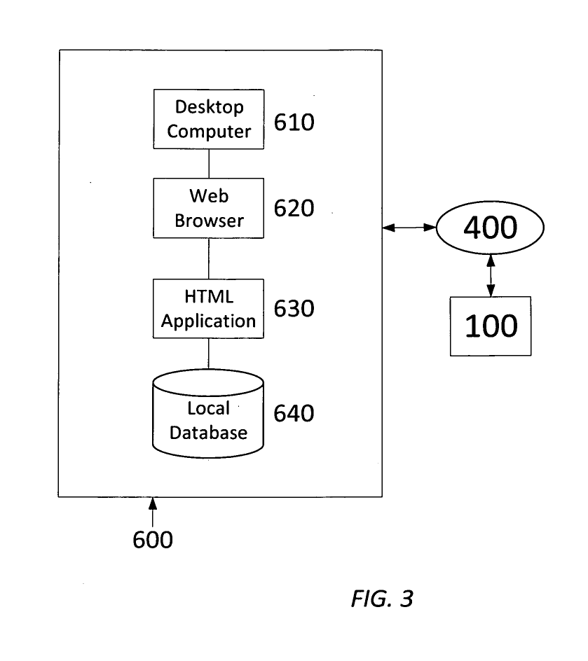

FIG. 3 is a block diagram illustrating the components of one embodiment of the HTML application on a desktop device. The desktop computer (610) is a standard computing device, either a desktop or laptop, operating a standard operating system capable of running a web browser (620). The web browser (620) is a standard internet browser capable of displaying a version of the HTML application (630) which is made available by the system (100) over the Internet (400). The HTML application (630) is a compiled version of the group of HTML pages which is targeted specifically for use on desktop devices (610) and viewed through a compatible web browser (620). The local database (640) is stored locally and updated by input from a reader of the HTML application and also from data received and transmitted over the Internet (400) to and from the system (100).

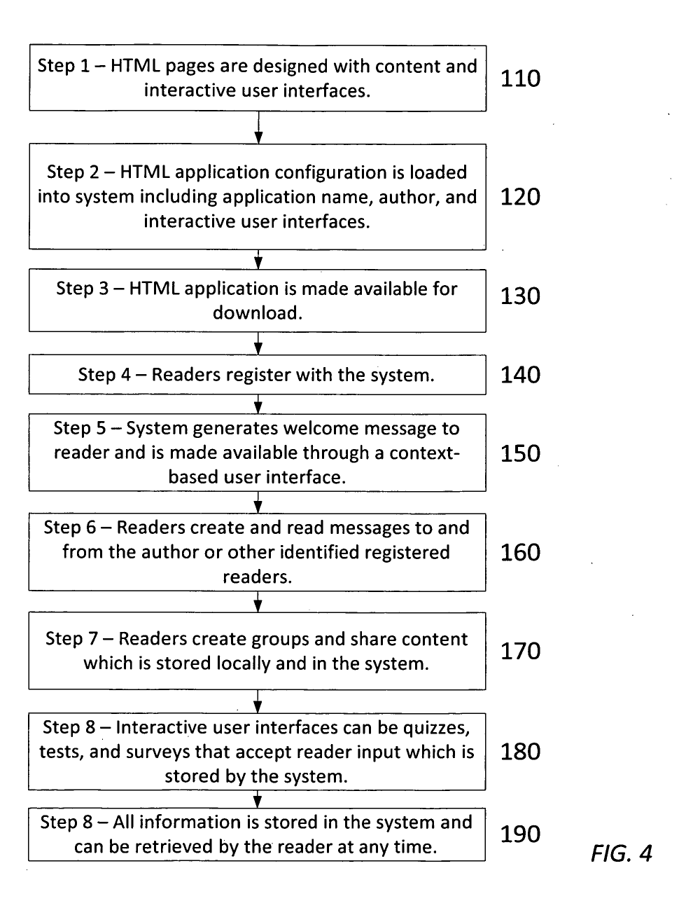

FIG. 4 is a flow diagram illustrating the method for creating an HTML application in the system to provide interactivity for the readers in accordance with one embodiment of the invention. In Step 1 (110), an HTML application is designed with content and interactive user interface components. In Step 2 (120), an HTML application configuration or profile is created and saved in the HTML application database. Also in Step 2 (120), the defining information related to the interactive user interfaces in the

HTML application are created and saved to the HTML application database. In Step 3 (130), the HTML application is made available for download in a separate store. This is not within the scope of the present invention. In Step 4 (140), readers that have downloaded an instance of the HTML application register with the system. In Step 5 (150), the system generates a predefined welcome message to the reader which is made available to them within the HTML application. In Step 6 (160), readers create and read messages to and from the author and/or other identified registered readers such as a teacher, group leader, or coach. In Step 7 (170), readers create groups and share content which is stored locally and in the system. This information can be shared with the author of the HTML application; other identified registered readers such as a teacher, group leader, or coach; groups; or every registered reader of the HTML application that has also shared content in the system. Content is specific to context-based user interfaces in the HTML application. Content that is shared with other readers is specific to each context-based user interface. When content is shared for a user interface, this content is made available to other readers that have also shared content for this same context-based user interface. In Step 8 (180), the context-based user interfaces can be quizzes, tests, or surveys whereby the registered reader can provide input which is stored by the system. In Step 9 (190), all information is stored in the system and can be retrieved by the registered reader at any time.

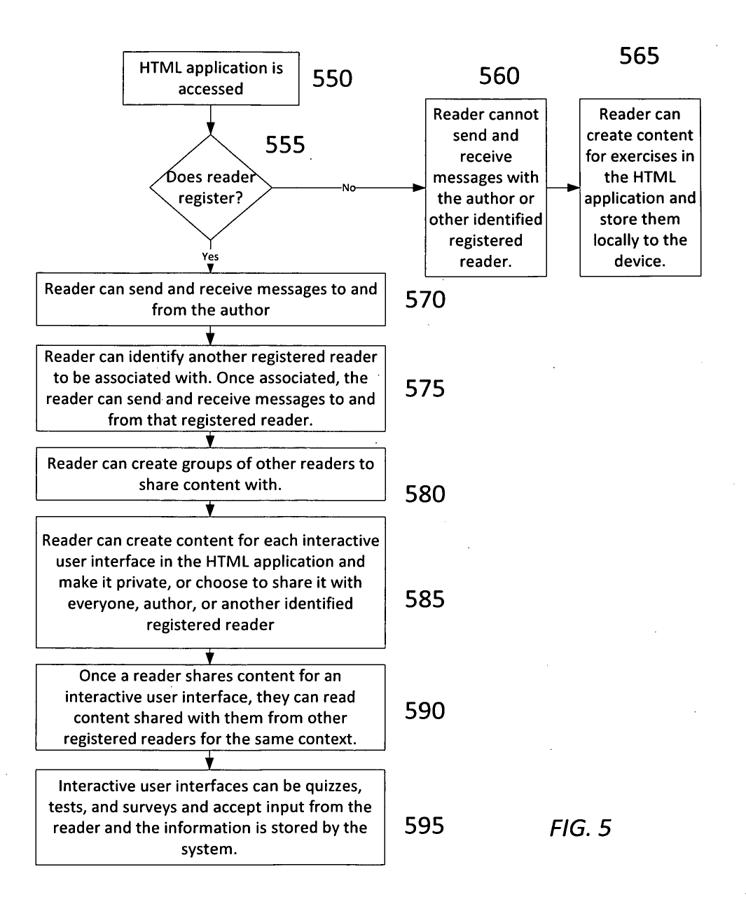

FIG. 5 is a flow diagram illustrating the method for a reader to register and use the interactive features of the HTML application in accordance with one embodiment of the invention. An HTML application is first downloaded (550) by a reader. A reader then makes a decision to register (555) their HTML application or not. If the reader decides not to register their HTML application (560), the reader will not be able to use some features of the HTML application such as sending and receiving messages with the author, other identified registered readers such as teachers, group leaders, or coaches. The reader can create (565) content for interactive context-based user interfaces in the HTML application and store them locally to the device, but they will not be able to share that content with other readers of the HTML application.

If the reader decides to register the HTML application (570), they can send and receive messages to and from the author. The reader can identify (575) another registered reader to be associated with. This other registered reader can be a teacher, group leader, or a coach. Once associated, the reader can send and receive messages to and from the other registered reader. The reader can create (580) groups of other readers to share content with. The reader can create (585) content for each context-based interactive user interface in the HTML application and make it private, or choose to share it with every other reader of the HTML application, the author, other identified registered reader, or any number of groups for which they are a member. When a reader has shared (590) content for an interactive user interface, they can read content shared by other registered readers.

Interactive context-based user interfaces (595) can be quizzes, tests, and surveys and accept input from the registered reader of the HTML application. The results are stored by the system and can be automatically delivered to other identified registered readers such as authors, group leaders, or coaches. The author, coach, or teacher can then send the results of the quantification of the quiz, test, or survey to the reader by creating content in the interactive user interface of the same context and share it with the reader.

1. A method for providing context-based communication to a user of an HTML application comprising the steps of:
a) accessing the HTML application on a computerized device on behalf of the first user;
b) allowing the user to provide unique identifying information to register with the system as a registered reader;
c) allowing the registered reader to navigate to a singular HTML page of the HTML application;
d) providing a user interface associated with the singular HTML page;
e) accepting content input from the registered reader through the user interface;
f) identifying said input with the context of the singular HTML page;
g) storing said input in a database local to the device;
h) checking for the presence of a network connection and if the HTML application can connect to the network;
i) transmitting said input over the network to the system on behalf of the registered reader; and
j) storing said input in a system database on behalf of the registered reader.

2. The method of claim 1, further comprising:
a) allowing the registered reader to identify all other registered readers of the current global context as third party readers of said input;
b) transmitting identifying information about said input to the system server;
c) allowing third party readers to request access to said input; and
d) transmitting said input to the third party readers.

3. The method of claim 1, further comprising:
a) allowing the registered reader to identify the author of the HTML application as a third party reader of said input;
b) transmitting identifying information about said input to the system server;
c) allowing the author to request access to said input; and
d) transmitting said input to the author.

4. The method of claim 1, further comprising:
a) allowing the registered reader to identify a second registered reader of the current global context as a third party reader of said input;
b) transmitting identifying information about said input to the system server;
c) allowing the third party reader to request access to said input; and
d) transmitting said input to the third party reader.

5. The method of claim 1, further comprising:
a) allowing the registered reader to identify a plurality of registered readers as a group of registered readers in the global context;
b) transmitting identifying information about said group of registered readers to the system;
c) allowing the registered reader to identify said group of registered readers as the third party readers of said input;
d) transmitting identifying information about said input to the system server;
e) allowing the group of third party readers to request access to said input; and
f) transmitting said input to the plurality of third party readers.

6. The method of claim 5, wherein the registered reader creates a second content input in a second interactive context-based user interface and identifies said group of registered readers as third party readers of said second content input allowing said group of registered readers to request access to said second content input.

7. The method of claim 1, further comprising:
a) allowing the HTML application to send a request on behalf of the registered reader to the system requesting shared content created by third party registered readers and identified as viewable by the registered reader; and
b) receiving said content from the system; and
c) displaying said content on the device of the registered reader.

8. The method of claim 7, further comprising:
a) allowing the HTML application to periodically check for the presence of a network and if present, transmit any local content created by the registered reader to the system to be saved by the system;
b) sending a request on behalf of the registered reader to the system requesting shared content created by third party registered readers and identified as viewable by the registered reader;
c) receiving said content from the system; and
d) storing said content in the local database of the device used by the HTML application.

9. The method of claim 1, wherein the user interface is a quiz, test, or survey that accepts structured input from the registered reader.

10. A method for providing context-based communication to a user of an HTML application comprising the steps of:
a) accessing the HTML application on a computerized device on behalf of the user;
b) allowing the user to interact with the HTML application as an unregistered reader;
c) allowing the unregistered reader to navigate to a singular HTML page of the HTML application;
d) providing a user interface associated with the singular HTML page;
e) accepting content input from the unregistered reader through the user interface;
f) identifying said input with the context of the singular HTML page; and
g) storing said input in a database local to the device.

11. The method of claim 10, further comprising:
a) allowing the unregistered reader to provide unique identifying information to register with the system as a registered reader; and
b) checking for the presence of a network connection and if the HTML application can connect to the network;
c) transmitting said input over the network to the system on behalf of the registered reader; and
d) storing said input in a system database on behalf of the registered reader.

12. The method of claim 10, further comprising:
a) allowing the registered reader to identify the author of the HTML application as a third party reader of said input;
b) transmitting identifying information about said input to the system server;
c) allowing the author to request access to said input; and
d) transmitting said input to the author.

13. The method of claim 10, further comprising:
a) allowing the registered reader to identify a′ second registered reader of the current global context as a third party reader of said input;
b) transmitting identifying information about said input to the system server;
c) allowing the third party reader to request access to said input; and
d) transmitting said input to the third party reader.

14. The method of claim 10, further comprising:
a) allowing the registered reader to identify a plurality of registered readers as a group of registered readers in the global context;
b) transmitting identifying information about said group of registered readers to the system;
c) allowing the registered reader to identify said group of registered readers as the third party readers of said input;
d) transmitting identifying information about said input to the system server;
e) allowing the group of third party readers to request access to said input; and
f) transmitting said input to the plurality of third party readers.

15. The method of claim 14, wherein the registered reader creates a second content input in a second interactive context-based user interface and identifies said group of registered readers as third party readers of said second content input allowing said group of registered readers to request access to said second content input.

16. The method of claim 10, further comprising:
a) allowing the HTML application to send a request on behalf of the registered reader to the system requesting shared content created by third party registered readers and identified as viewable by the registered reader; and
b) receiving said content from the system; and
c) displaying said content on the device of the registered reader.

17. The method of claim 16, further comprising:
a) allowing the HTML application to periodically check for the presence of a network and if present, transmit any local content created by the registered reader to the system to be saved by the system;
b) sending a request on behalf of the registered reader to the system requesting shared content created by third party registered readers and identified as viewable by the registered reader;
c) receiving said content from the system; and
d) storing said content in the local database of the device used by the HTML application.

18. The method of claim 10, wherein the user interface is a quiz, test, or survey that accepts structured input from the registered reader.
